(19) United States
(12) Patent Application Publication
(10) Pub. No.: US 2011/0142562 A1
(43) Pub. Date: Jun. 16, 2011

(54) Method and System including a Horizontal Turning Head and Turning Bar for a Milling Machine

(76) Inventor: Dan Alexander Sturges, Lake Oswego, OR (US)

(21) Appl. No.: 12/966,309

(22) Filed: Dec. 13, 2010

Related U.S. Application Data
(60) Provisional application No. 61/286,251, filed on Dec. 14, 2009.

(51) Int. Cl. B23C 9/00; B23Q 37/00; B23B 1/00

(52) U.S. Cl. 409/131; 409/240; 29/27 A

(57) ABSTRACT

A system for converting a conventional vertical milling machine into a lathe includes a tool adapted to insert into the vertical spindle of the milling machine and is adapted to present a cutting edge aligned with the center vertical axis of the vertical milling machine spindle. A turning head assembly includes a horizontal spindle driven by an electric motor having an electric cooling fan. The turning head couples to the vertical milling machine so that it is adjustable in both the x and y directions. When used together, the turning bar and turning head enable conversion of milling machine to a lathe.

### PRIORITY CLAIM

The present application claims benefit under 35 USC Section 119(e) of U.S. Provisional Patent Application Ser. No. 61/286,251 filed on 14 Dec. 2009. The present application is based on and claims priority from this application, the disclosure of which is hereby expressly incorporated herein by reference.

### BACKGROUND

The present invention relates generally to milling machines and more specifically to an apparatus for attaching to a milling machine for turning a work piece in a horizontal plane to covert a milling machine to function as a lathe.

Computer numerical controlled (CNC) milling machines and lathes are well understood in the machine tool art. Milling machines include a vertically oriented and removable tool. The tool-head points downward and is rotated about its vertical axis by a power driven spindle. The spindle is moveable along this vertical, or z-, axis. Depending on the specific tool mounted in the rotating spindle, the milling machine performs many diverse machining operations including drilling, cutting, milling, reaming, and boring, for example, but not turning. In these varied operations, the work piece is typically mounted on a two-axis (x and y) table. Thus, the rotating tool moves downward to contact the work piece and the two-axis table enables x-y positioning of the work piece relative to the tool. The work piece is fixably secured to the two-axis table by varied known mounting means including bottom or side clamping of the work piece.

In contrast, a CNC lathe rotates the work piece, which is clamped into a horizontally positioned spindle. The cutting tool secures to a two or three- axis table that enables the tool to move in the x, y, and z directions relative to the fixed position (albeit rotating about a horizontal axis) work piece.

Both the Lathe and Milling Machine are irreplaceable tools for most machine shops. However, CNC machines are costly compared to manual operated machines and, therefore, many machine shops cannot afford to purchase and maintain both a CNC Lathe and CNC Milling Machine. A common practice is to use both a manual lathe, such as a Hardinge HLV or any such engine or tool-room lathe and a CNC milling machine in a given shop. This approach, although economical, leaves the machine shop with gaps in the types of work-orders they can fill, as not all desired products can be made with a CNC Milling machine and manual lathe and meet the cost and or quality parameters necessary to be successful.

Recognizing this shortcoming, others have attempted to convert their accurate CNC milling machines to perform accurate, cost-effective, and competitive services by adapting an existing CNC milling machine to rotate a work piece in the horizontal plane. One representative prior art system for adopting a manual lathe for use with a CNC milling machine is described by Jackson et al. in U.S. Pat. No. 7,386,362 issued on 10 Jun. 2008. Jackson describes a cutting tool held in a rotatable spindle provided by a conventional milling machine. The spindle head is capable of translation along a vertical path by conventional driving means under the control of a computer. Additionally, a lathe including a base and rotating (horizontal) spindle is coupled to a two-axis table, where movement in both the x and y directions is parallel to the horizontal axis of rotation of the lathe spindle. The axis of rotation of the lathe spindle is perpendicular to the axis of rotation of the mill spindle. A conventional tailstock further assists in securing the work piece in the lathe spindle.

One limitation of the Jackson device is that it requires a detent or other indexing feature to eliminate rotation of the cutting tool about the spindle axis. This detent or other indexing feature is required because if the cutting tool is free to rotate, flex, or otherwise move about the spindle axis, the ability to accurately cut materials will be lost because: 1) Cutting forces will displace the cutting tool's position in the X and Y axes thus making dimensional repeatability and control impossible; And, 2) the cutting tool will lack the positional rigidity or “stiffness” required to generate the cutting forces required to successfully cut metals and other materials. Jackson does not address any solution that is capable of adequately eliminating the rotation or flexing of a cutting tool about a milling machine's spindle axis.

Other known prior-art attempts to combine lathe and milling machines into one, economical system include the milling table lathe described by Smith et al. in U.S. Pat. No. 4,057,893 issued on 15 Nov. 1977. Smith's disclosure instructs or requires that the cutting tool must be mounted to a large, awkward and heavy steel or cast iron “bridge” which must be laboriously attached to the milling machine. One drawback is that this “bridge” precludes the milling machine from being used as a milling machine for as long as the “bridge” is attached to the milling machine. It is demonstrably inconvenient to attach and detach the “bridge” to the milling machine.

Another drawback of Smith's concept is lack of “bridge” stiffness. The bridge must necessarily free span the milling machine's XY table. This relatively long span distance necessitates that the bridge be inordinately thick in order to not appreciably deflect under application of cutting forces. Deflection of the cutting tool (due to cutting forces) undermines all attempts at precision control of work piece dimensions, repeatability and surface finish quality.

Yet another known prior-art attempt to combine lathe and milling machines into one, economical system includes the milling machine lathe attachment of Maker described in U.S. Pat. No. 5,301,405 issued on 12 Apr. 1994. One drawback of Maker's concept is that the lathe spindle or “headstock” is large, heavy and awkward. As with Smith's concept, attaching and removing the device is impractically difficult. Another drawback is that the headstock will deflect under cutting forces to render the Maker's device impractical for precision machining. Maker teaches that the headstock is necessarily located far from its attachment point on the milling machine; this distance leads directly to deflection of the headstock under cutting forces. Headstock deflection undermines all attempts to perform precision machining.

Thus, there remains a need for a system, tool and method of use whereby a conventional or CNC milling machine can also operate as a lathe and approximate or imitate the tolerances and output of a more expensive multiple axis CNC machining center. There is a need for the milling machine to present a cutting point or edge, aligned in a vertical orientation to approach the work piece at a given z-direction in the horizontal plane, yet allow x and y direction relative movement of the work piece relative to the cutting edge, while simultaneously spinning the work piece in the horizontal plane. Moreover, the cutting edge or point should be at the geometric center (that is aligned with) of the milling machine's spindle vertical axis. The cutting tool should further be bi-directional and dynamic, and still lock at a given z-axis distance.

All prior art examples don't address the rigidity or stability of the tool to work piece relationship and the prior-art, therefore, results in unwanted vibrations and tool and/or work piece movement. This results in a process that is not repeatable and produces inaccuracies in the operation. Further, a common shortcoming of the prior art is the precise positioning of the cutting edge relative to the work piece—the prior art cannot present a single cutting edge at each location of the work piece, this necessitates tool changes when working the front and switching to the back or the left side to the right side, for example.

### DRAWING

FIG. 1 is an offset side view of a tool according to the present invention.

FIG. 2 is a bottom view of the tool of FIG. 1.

FIG. 3 is a left side view of the tool of FIG. 1.

FIG. 4 is a bottom view of the tool of FIG. 5.

FIG. 5 is a front view of the tool of FIG. 1.

FIG. 6 is a bottom view of a second tool according to another preferred embodiment of the present invention.

FIG. 7 is a front view of the second tool of FIG. 6.

FIG. 8 is a left side view of the tool of FIG. 7.

FIG. 9 is an offset-side view of the tool of FIG. 7.

FIG. 10 is an offset-front view of a lathe turning head according to a preferred embodiment of the present invention.

FIG. 11 is a top view of the lathe turning head of FIG. 10.

FIG. 12 is a left side view of the lathe turning head of FIG. 10.

FIG. 13 is a front view of the lathe turning head of FIG. 10.

FIG. 14 is an offset-side view of the lathe turning head of FIG. 10 with the cowling and belt guard removed.

FIG. 15 is an offset-side view of the lathe turning head of FIG. 14 with the cowling and belt guard in place.

FIG. 16 is an offset frontal view of the system according to a preferred embodiment of the present invention.

FIG. 17 A-B, a top view, show the cutting tool of a preferred embodiment of the present invention in relation to a work piece and further illustrate a single cutting tool being able to access all sides of the work piece.

FIG. 18 is an offset frontal view of a second preferred embodiment of the present invention.

FIG. 19 is a detail view along line 19 of FIG. 18.

FIG. 20 is an offset front view of an indexing pulley head according to another preferred embodiment of the present invention.

FIG. 21 is a side view of the pulley head of FIG. 20.

FIG. 22 is an offset rear view of the pulley head of FIG. 20.

FIG. 23 is a front view of a stylus according to a second preferred embodiment of the present invention.

FIG. 24 is an offset front view of the stylus of FIG. 23 in relation to an x-y slider of the second preferred embodiment of the present invention.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

The present invention overcomes the drawbacks and limitations of the prior-art. Specifically, the present invention overcomes the limitations of Jackson by presenting a vertical cutting edge in the geometric center of the mill spindle's axis of rotation. The motion of the present invention's cutting tool about the spindle axis does not move the cutting tool's cutting edge or point in the X or Y axes. That is to say, the rotation or other motion of the present invention's tool about the spindle axis does not affect the dimensions of the work piece. This is because the cutting edge or point of the cutting tool is aligned with the spindle axis; that is, the cutting edge or point is concentric with the spindle axis. This feature, therefore does not require a detent or indexing feature and the spindle does not need to be locked in any angular position.

Another advantage gained by the present invention over the conventional teachings in the art is that the tool of the present invention is not deflected in the X or Y-axes by cutting forces. Given that the cutting plane of the cutting tool is horizontal, the cutting forces are therefore vertical, i.e. cutting forces are directed up the Z-axis of the milling spindle and not in the X or Y axes. Given that the cutting action of this tool as aligned with spindle axis, there is no cantilevered distance between the cutting force and spindle axis and the milling spindle is uniquely designed to withstand these typical cutting forces. Thus, cutting forces do not impart dimensional uncertainty to the work piece and more productive work is thereby achieved because of the Turning Bar's inherent rigidity and stiffness.

One key aspect of the current invention is the cutting tool. Unlike the cutting tool associated with conventional lathes, which require the selection of either a right- or left-cut tool direction, the present invention has a bi-directional cutting head. A conventional lathe, for facing, roughing, or finishing operations, for example, requires the positioning of a tool that corresponds to the side of the work piece the tool addresses. Thus, a conventional lathe requires duplicate, albeit left or right side, sets of cutting tools. Switching the cutting tools from the left side to the right side requires set-up time and precision, reducing the throughput or efficiency of the operation. In contrast, because of the mounting technique, the cutting tool of the present invention is bi-directional, and there is, therefore, no need for separate left or right cutting tools as instructed in the prior art. The cutting tool, or insert, has a cutting edge. In the present invention, the cutting edge is concentric to the shank axis. To accomplish this, a unique tool, called a turning bar, presents the cutting edge to the work piece. The turning bar mounts to the mill spindle in a conventional manner.

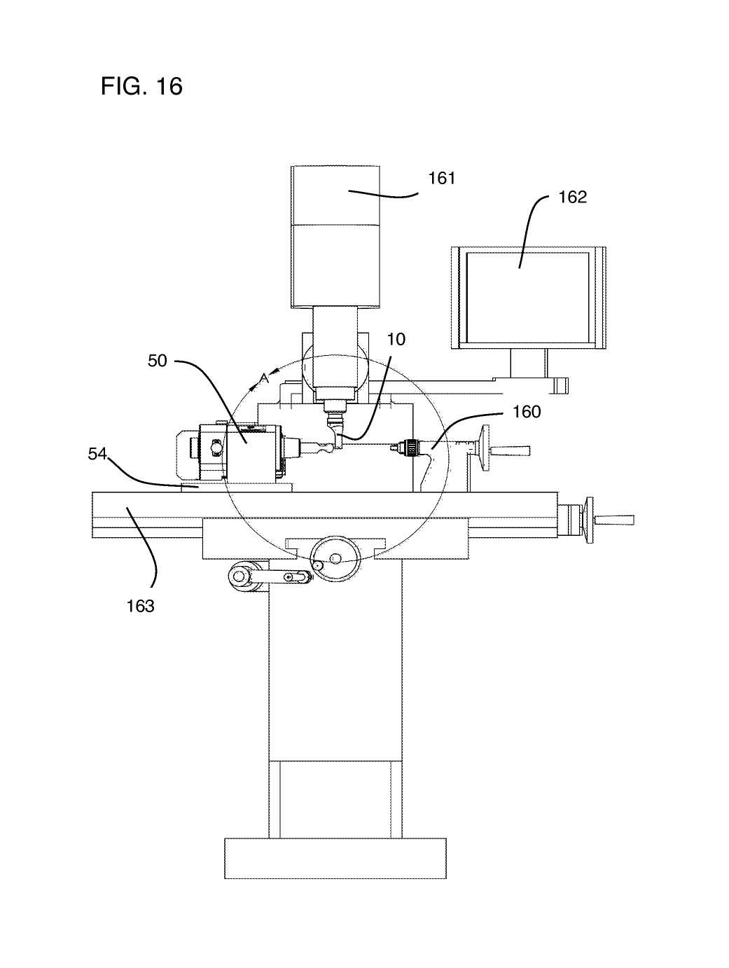

FIGS. 16, 18 and 19 illustrate a conventional vertical milling machine 161, its construction and use being well understood in the art, modified with a preferred embodiment of the present invention including a turning head 50 mounted to a plate 54 coupled to the deck 163 of the milling machine. A conventional tailstock further couples to the deck as would be conventionally understood in this art. A specialized tool, such as a “turning bar” 10 or turning bar 34 (not shown in this view) according to a preferred embodiment couples to the vertical mill. The turning bar is a new term not used in this industry, the closest term in the art is a “tool holder”. The details of these turning bar tools and components follow.

The turning bar 10 comprises a cylindrical shank 12 having a shank axis 14 vertically extending along the long axis of the turning bar, and this axis is concentric to the center of the mill head spindle when mounted to the milling machine spindle. In one preferred embodiment, the shank 12 consists of a standardized R8 shank, common to this art. In another preferred embodiment the shank consists of a ¾″ cylindrical stub.

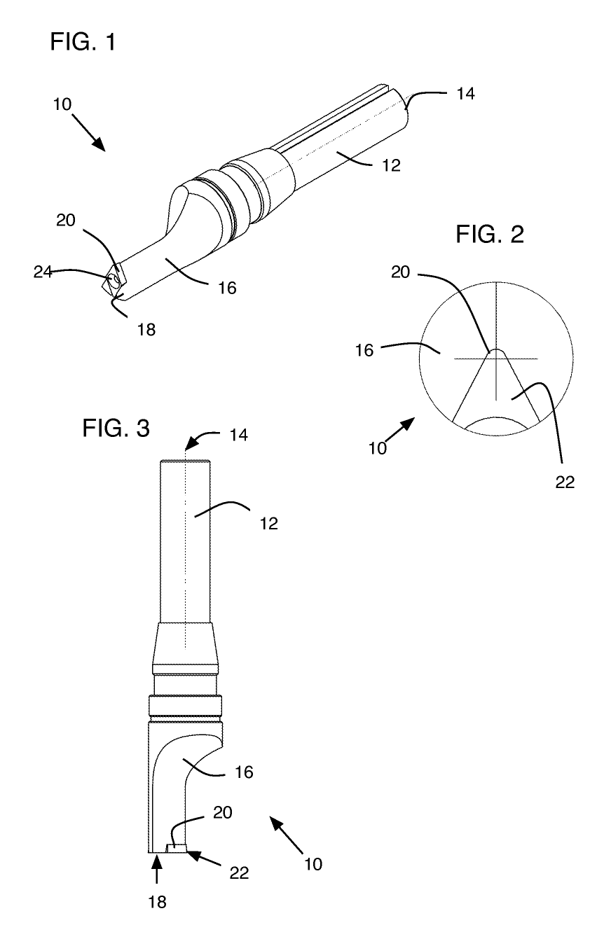

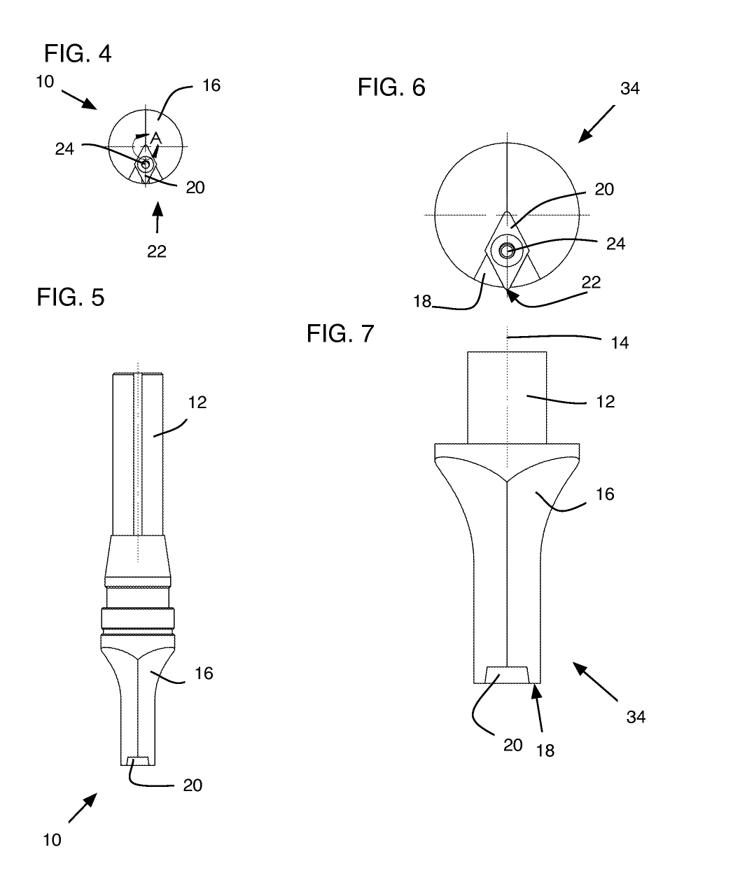

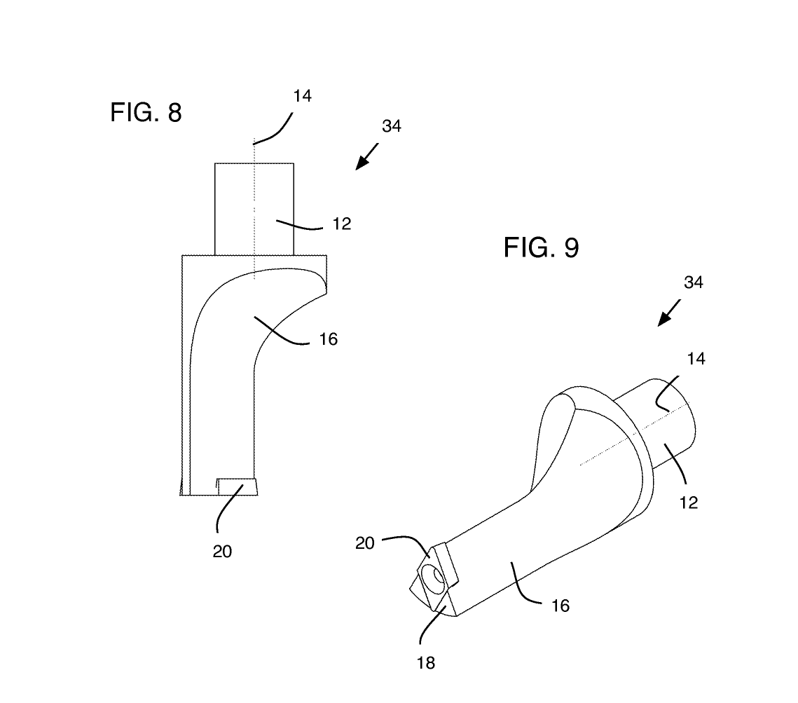

FIGS. 1-5 illustrated such a typical turning bar contemplated by this preferred embodiment of the present invention. The turning bar 10 further comprises a head 16 tapering from the shank end to a narrow v-shaped insert end 18, which adapts to releasably couple a conventional tool insert 20. The tool insert 20 has a cutting edge 22. The insert 20 attaches to the insert end 18 in a conventional way, for example, by means of a setscrew 24. A multitude of inserts will work in the Turning Bar. Common insert types include square, parallelogram, circular, hexagonal, triangular, diamond and other typical indexable insert shapes. Suppliers of typical indexable inserts include: Valentine, Seco, Carboloy and Ingersol companies. An example insert is Part No. DCGT32.52MJ from Mititoyo Company.

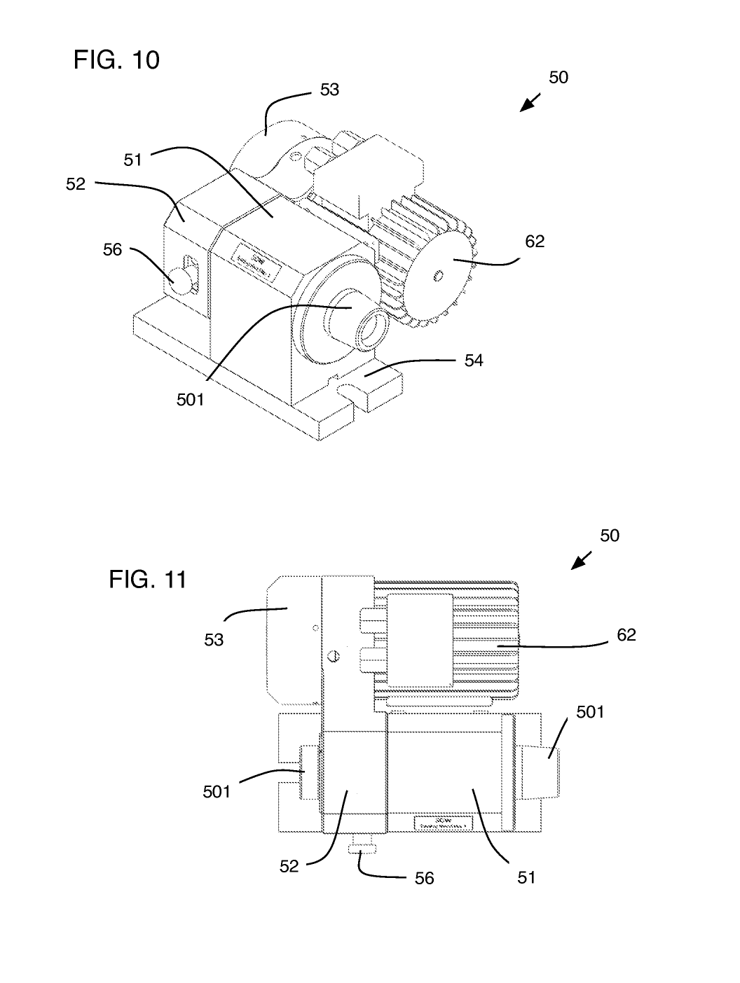

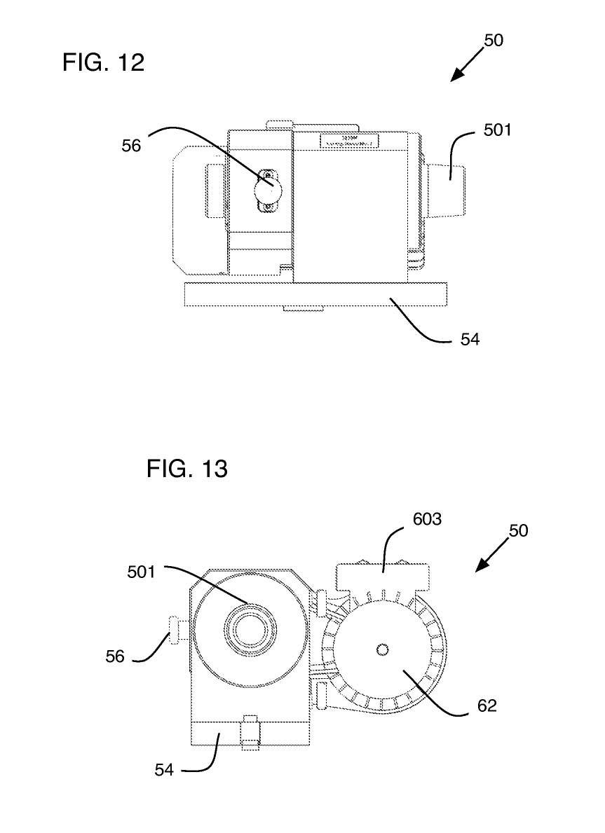

FIGS. 10-13 illustrate another component of the system of a preferred embodiment of the present invention, a “turning head” assembly 50. The term “turning head” is newly coined and is not generally understood in the art. The closest term used in the art is “headstock assembly”. The turning head assembly includes a mounting base plate 54, which includes features for releasably mounting the assembly 50 to a surface provided by the mill. For example, the plate 54 can be clamped or bolted to the two-axis table on the milling machine or held in a vise which in turn is attached to said table: Accordingly, notches or cut-out, or through-holes are included on the base plate to facilitate the secure coupling of the plate to the milling machine table.

A spindle housing 51 conventionally attaches to the base plate. The spindle housing includes a headstock, main spindle 501, speed change mechanism, and change gears. The headstock is required to be made as robust as possible due to the cutting forces involved, which can distort a lightly built housing, and induce harmonic vibrations that will transfer through to the work piece, reducing the quality of the finished work piece. One commonly available main spindle, headstock, bearings, and related gear includes a kit from Dunham Tool Co. Model No. 50MT-2, for example.

The main spindle 501 is generally hollow to allow long bars to extend through to the work area. This reduces preparation and waste of material. The spindle runs in precision bearings and is fitted with some means of attaching work holding devices such as spindles or faceplates. This end of the spindle usually also has an included taper, frequently a Morse taper, to allow the insertion of tapers and centers.

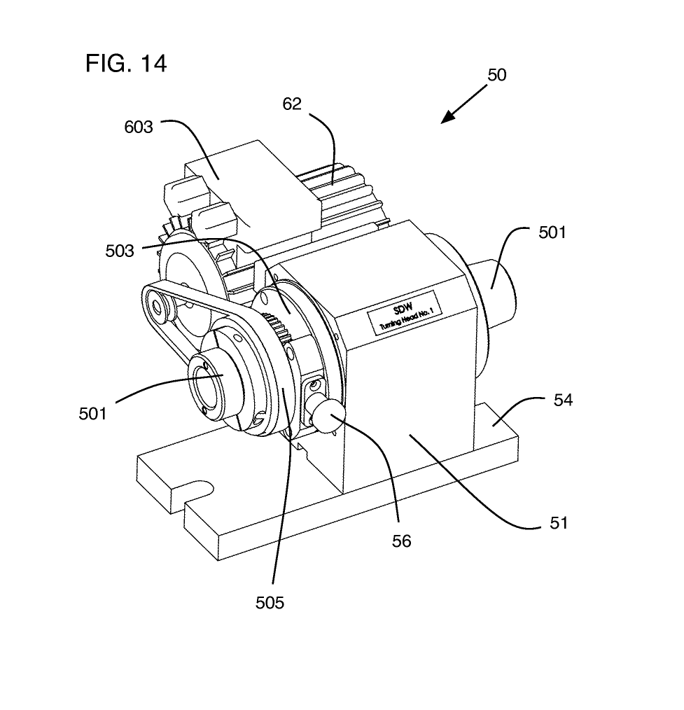

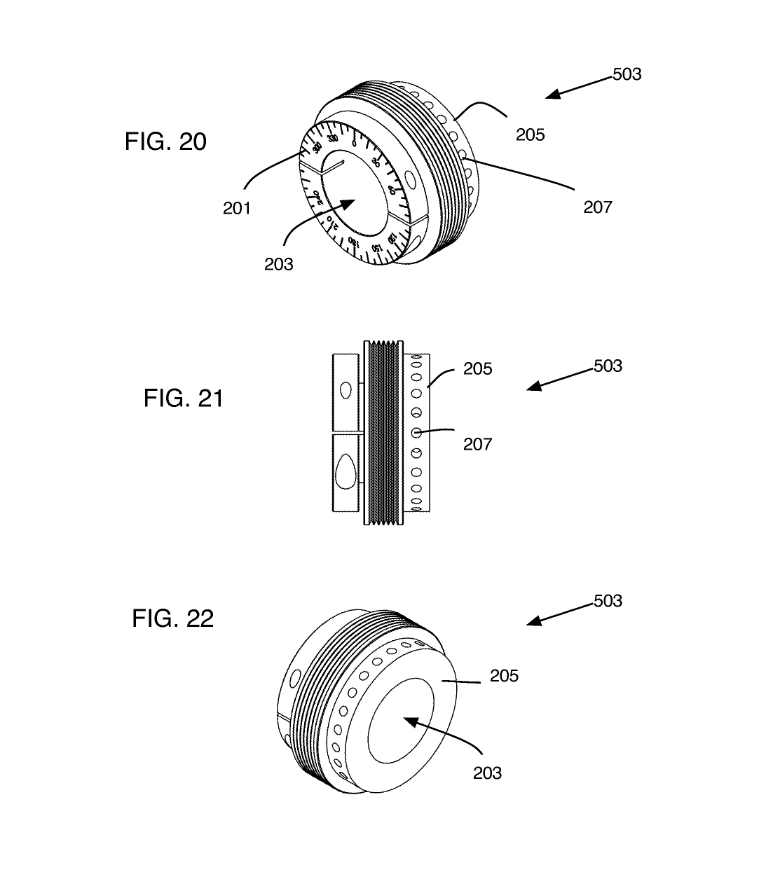

As FIG. 14 illustrates, the turning head 50 includes a poly-v belt pulley 505 driven by a dedicated electric motor 62 drives the spindle 501. Speeds are infinitely variable vis-a-vis an electronic speed control. The pulley further couples to an indexing head 503 (FIGS. 20-23 detail this indexing head 503). A conventional electric motor 62, such as a ½ horsepower electric motor from Baldor Electric Motor Company, is modified in a preferred embodiment of the present invention. Normally, the cooling fan mounts to the front of the motor. Conventional cooling fans run off the single, common shaft that runs a pulley that turns the spindle. Thus, this direct drive influenced the fan speed and low spindle rotation speeds equated to low fan speeds: This often caused early failures in the motor as the fan speed was inadequate to provided the needed cooling airflow across the motor. Also, the front location of the fan does not work in this application as it interferes with tool positioning of work pieces in the lathe head. To overcome these problems, the present invention de-couples the fan from the pulley 57 and pulley shaft and removes the fan from the front of the motor. In its place an auxiliary fan 53 mounts to the back of the motor assembly 62. This auxiliary fan is an electric fan such as a fan from U.S. Toyo Fan Co. Model No. USTF120381155T. This fan runs independent of pulley speed and is not related to the pulley shaft. Accordingly, the auxiliary fan can be programmed to run at an optimal speed to cool the motor independent of the spindle speed and can be timed to continue running even if the pulley is not rotating. Further, its location does not interfere with tools on the spinning work piece. Motors of this type are called “forced ventilation motors” and are available commercially, but are too large and heavy for this application, hence my modification of the standard motor, just described.

The turning head 50 further includes an index pin 56 and indexable pulley 55 with index features 58, the construction and use of which is well understood in the lathe and mill machine arts. FIGS. 20-23 illustrate a suitable indexable pully head 503. As such the indexing head includes a graduated face 201 with reference marks, numbers, or letters. A hollow center 203 enables the workpiece to insert therethrough. Indexing is accomplished by having an insertable pin (such as pin and handle 56 previously discussed) selectively inserting into any given one hole of a plurality of holes 207 on the head body 205.

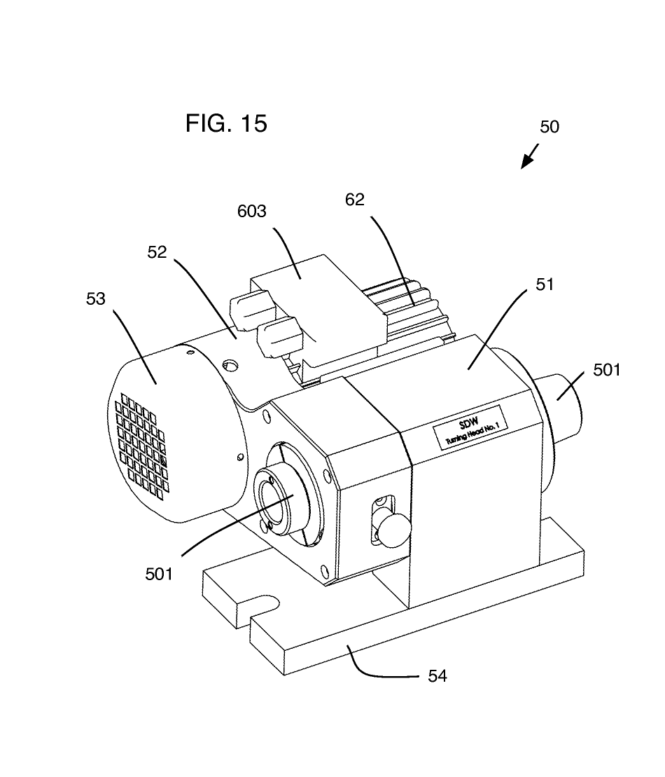

As FIG. 15 further illustrates, the auxiliary fan 53 is enclosed in a fan cowling, the fan cowling mounts to a pulley guard 52. The pulley guard, in turn, mounts to the spindle housing 51. The speed control unit 603 for the electric motor cooling fan assembly is modified to bring power to the auxiliary cooling fan. We connected to power point within the speed control unit and ran power out to the auxiliary fan in the same conductor cable as the power lines going to the spindle motor. That is, the power cord going to the auxiliary fan has 6 conductors in it: four (4) for the spindle motor and two (2) for the auxiliary fan.

Optionally, a tailstock 160 selectively couples to the two-axis table of the milling machine to assist supporting work pieces, as would be conventionally understood in the lathe arts. Other end tools to create a bore, thread, etc. also can be used with this invention. This tailstock is shown in FIG. 16, for example and its construction and use is well understood in the art.

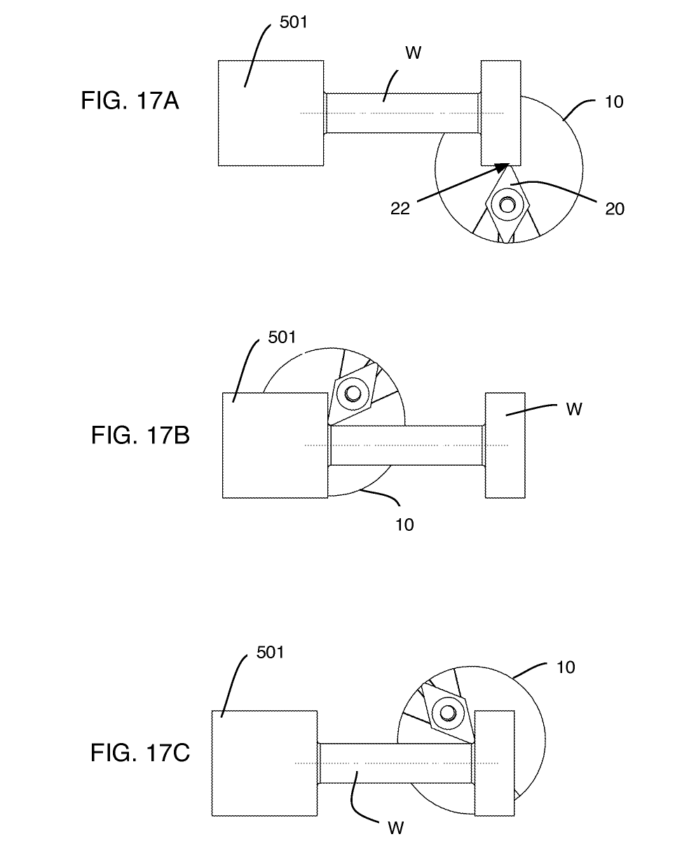

FIGS. 17A, 17B, and 17C illustrate the insert 20 with cutting edge 22 on the turning bar 10 in relation to a work piece (W) held in a turning head main spindle 501 of the present invention. It will be appreciated that, for a given z-axis location, the cutting edge can address the work piece at any point in the x-y plane on either side of the work piece, without needed to change the tool (this is unlike the conventional teaching in this art).

Although not illustrated in the drawing, a stepper/or servo-motor can be used to rotate the turning bar 10 (or turning bar 34) into any direction—lock it in or can freely rotate (hand control).

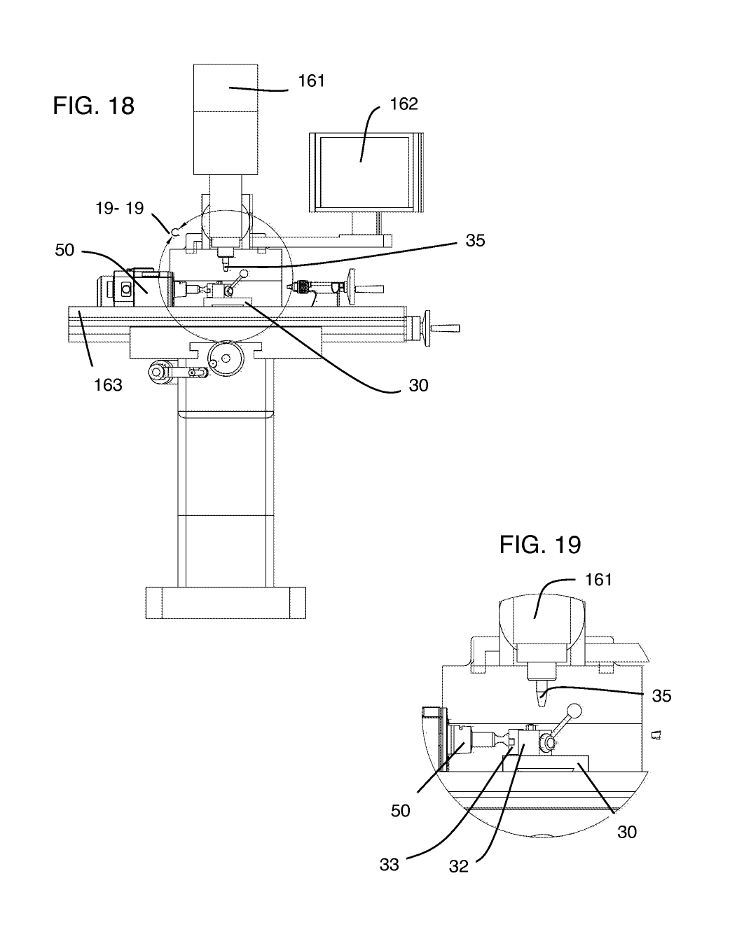

FIGS. 18 and 19 illustrate an additional component of a second preferred embodiment of the present invention and an alternative method of using the milling machine as a lathe. In this embodiment, a free-floating 2-axes slide system 30, i.e. XY system, is attached to the milling machine table. To this XY system 30 is attached a typical lathe tool post 32 with choice of cutting tool or any other tool commonly available to lathe users.

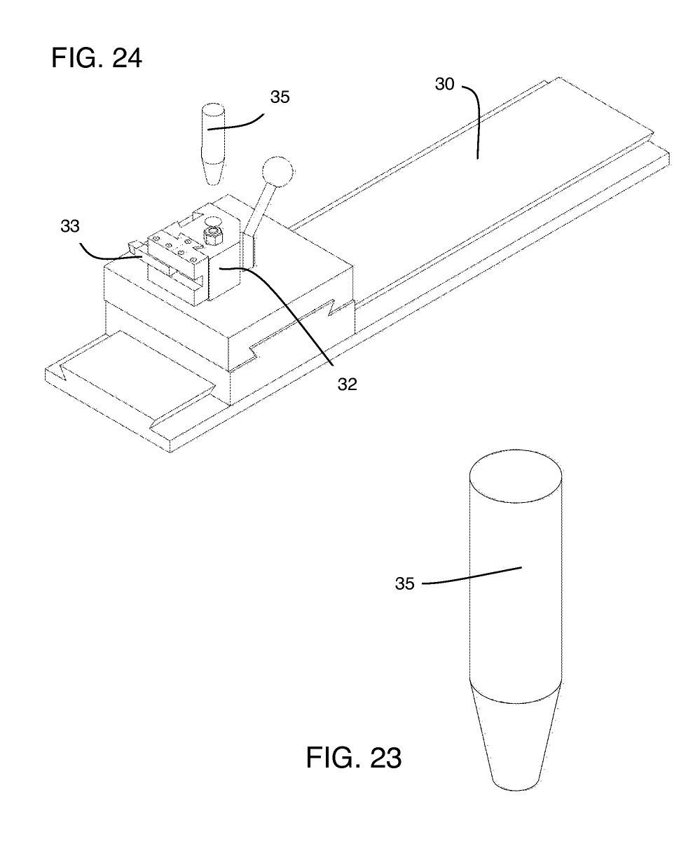

FIGS. 23-24 illustrate a second contemplated tool for various preferred embodiments according to the present invention. For example, in lieu of the turning bar 10 (of FIGS. 1-5, for example), a simple cylindrical shaft (stylus 35), with a tapered end, is fixed into the milling machine spindle (by way of a collet or similar device). Call this piece the “XY Stylus” 35. The tapered end 16 of the XY Stylus 35 will engage a hole in the tool post and be locked in a fixed Z-axis position. Similar to the turning bar 10, the stylus tool 35 includes a cylindrical shank 12 having a shank axis 14 vertically extending along the long axis of the turning bar, and this axis is concentric to the center of the mill head spindle when mounted to the milling machine spindle. In one preferred embodiment, the shank 12 consists of a standardized R8 shank, common to this art. In another preferred embodiment the shank consists of a ¾″ cylindrical stub, for example. This stylus tool 35 includes a head 16 tapering from the shank end 12 to a narrow v-shaped insert end 18, which adapts to releasably couple a conventional tool insert 20. The tool insert 20 has a cutting edge 22. The insert 20 attaches to the insert end 18 in a conventional way, for example, by means of a setscrew 24.

The tool post is now fixed in relation to the milling machine frame; it cannot move in X, Y or rotate relative to the milling machine, regardless of the milling machine table's movements.

The Turning Head 50, which is securely mounted to the x-y table of the milling machine, is now similar to its use with the Turning Bar 10 or 34, but this time the milling machine includes the stylus 35 in lieu of a turning bar tool. The stylus 35 engages the tool post 32 mounted on an x-y slider 30. The tool post 32 carries any lathe tool desired, such as a cutting tool 33 as FIGS. 18, 19, 23 and 24 show, or any other typical lathe tools including turning, facing, boring, knurling, etc. The milling machine's axes may move the Turning Head in the X and/or Y axes thus permitting cutting or turning of the work piece in any combination of X and/or Y needed.

Additional tools and devices may be coupled to the deck of the milling machine. For example, the turning head can be mounted to a x- and y-direction movable deck and a stationary cutoff tool can be positioned so that when machining is complete that the turning head can deliver the work piece to the stationary tool to allow it to cut off the work piece from the horizontal spindle 501. One contemplated cut off tool 33 includes a 3/32′inch wide cut-off tool commonly available for lathes, such as those bade by the Cleveland Tool Co.

Although the invention has been particularly shown and described with reference to certain embodiments, it will be understood by those skilled in the art that various changes in form and detail may be made without departing from the spirit and scope of the invention. And, although claims are not required, I claim at least:

I claim:

1. A system for converting a vertical milling machine to a lathe, the vertical milling machine including a means for moving a table in an x and y direction and a vertical spindle movable along a z-axis, the system comprising:
a turning head assembly adapted to couple to the vertical milling machine, the turning head comprising a horizontal spindle adapted to receive a work piece;
an electric motor assembly adapted to turn the horizontal spindle by means of a pulley driven by the motor and coupled to the turning head assembly;
an electric auxiliary fan adapted to cool the electric motor assembly independent of a belt speed of the pulley; and
a tool adapted to insert into the vertical spindle.

2. The system of claim 1 wherein the tool further comprises:
a turning bar carried by the vertical spindle;
the turning bar comprising a head tapering from the shank end to a narrow v-shaped insert end, which adapts to releasably couple a conventional tool insert having a cutting edge, the turning bar further having vertical axis aligned to coincide with the vertical spindle axis and adapted to align the cutting edge in line with the vertical axis of the milling machine.

3. The system of claim 1 wherein the turning head assembly includes a housing adapted to encapsulate the horizontal spindle, the electric motor and the electric auxiliary fan.

4. The turning head of claim 1 wherein the horizontal spindle further comprises:
a lathe head mounted to a base plate, the base plate adapted to selectively couple to the table of the milling machine.

5. The system of claim 1 wherein the tool comprises:
a turning bar comprising a simple cylindrical shaft having a shank axis vertically extending along the long axis of the turning bar, and this axis is concentric to the center of the mill head spindle when mounted to the milling machine spindle, the shaft further comprising a tapered end and an opposite, cylindrical shank end adapted to selectively couple to the vertical spindle;
the tapered end further comprises a narrow v-shaped insert end, adapted to releasably couple a conventional tool insert.

6. The system of claim 1 further comprising a tailstock adapted to couple to the vertical milling machine.

7. The system of claim 1 further comprising a CNC machine interface adapted to position the turning head in the x and y directions relative to a z direction on of the vertical spindle.

8. The system of claim 1 wherein the turning head further comprises:
an indexable pulley head coupled to the horizontal spindle, the indexable pulley head adapted to selectively position the horizontal spindle in a first locked position.

9. The system of claim 1 wherein the tool comprises:
a stylus comprising a simple cylindrical shaft having a shank axis vertically extending along the long axis of the tool, and this axis is concentric to the center of the mill head spindle when mounted to the milling machine spindle, the shaft further comprising a tapered end and an opposite, cylindrical shank end adapted to selectively couple to the vertical spindle.

10. The system of claim 9 further comprising:
an x-y slider coupled to the milling machine means for moving a table in an x and y direction, the x-y slider operable to move in an x-y, the x-y slider adapted to receive a tool post, the tool post adapted to selectively couple to the stylus; the tool post further adapted to receive a lathe tool.

11. A method of operating a vertical milling machine as a horizontal lathe, the method comprising:
providing a vertical milling machine having a selectively rotatable vertical spindle and control of a horizontal table in the x and y directions and vertical control of the spindle in the z direction;
providing a tool adapted to insert into the vertical spindle; and
providing a turning head having a horizontal spindle; and
mounting the turning head to the milling machine so that the vertical spindle and horizontal spindle arrange substantially at about a 90-degree angle to each other; the turning head mounting to the vertical milling machine to enable x and y positioning of the horizontal spindle relative to the z-axis movement of the vertical spindle.

12. The method of claim 11 wherein:
providing the tool further comprises providing a turning bar.

13. The method of claim 11 wherein:
providing the tool further comprises providing a stylus, the stylus adapted to engage the vertical spindle of the milling machine;
providing an x-y slider having a tool post with a lathe tool coupled to the tool post, the tool post further adapted to receive an end of the stylus.

14. The method of claim 11 further comprising:
providing a turning head further comprising an electric motor assembly coupled to the vertical spindle, the electric motor assembly further including an electric auxiliary fan coupled to the belt guard wherein the fan runs independent of the pulley.

15. The method of claim 11 wherein providing a tool further comprises:
providing a turning bar comprising a head tapering from the shank end to a narrow v-shaped insert end, which adapts to releasably couple a conventional tool insert having a cutting edge, the turning bar further having vertical axis aligned to coincide with the vertical spindle axis and adapted to align the cutting edge in line with the vertical axis of the milling machine.

16. The method of claim 11 wherein providing a tool further comprises:
providing a tool comprising a simple cylindrical shaft having a shank axis vertically extending along the long axis of the turning bar, and this axis is concentric to the center of the mill head spindle when mounted to the milling machine spindle, the shaft further comprising a tapered end and an opposite, cylindrical shank end adapted to selectively couple to the vertical spindle.
